(19) United States
(12) Patent Application Publication
(10) Pub. No.: US 2013/0160360 A1
(43) Pub. Date: Jun. 27, 2013

(54) SEED SPROUTER AND METHOD OF USE

(71) Applicant: Dustin W. Palmer, Orem, UT (US)

(72) Inventor: Dustin W. Palmer, Orem, UT (US)

(21) Appl. No.: 13/333,730

(22) Filed: Dec. 21, 2011

(51) Int. Cl. A01G 9/02

(52) U.S. Cl. 47/66.7; 47/87

(57) ABSTRACT

Exemplary sprouters may provide automatic water level adjustment for soaking seeds and growing sprouts from those seeds in trays formed from a hydrophobic material and with holes in the bottom surface of the tray sized such that the surface tension of pure water and the hydrophobic properties of the tray material resists passage of the pure water through the holes. The automatically adjusting may be facilitated by germinating seeds soaking in water changing the surface tension of the soaking water and reducing the resistance to passage through the holes.

### FIELD

This application relates generally to horticulture implements. More particularly, this application relates to sprouters for growing and harvesting sprouts and methods of using sprouters.

### BACKGROUND

Seed sprouting is the practice of germinating seeds into sprouts that may be eaten raw or cooked. Some common varieties of sprouts grown and eaten including alfalfa, mung bean, broccoli, watercress, wheat berry, soybean, and clover. Because various health benefits that have been identified with eating sprouts, many people have become interested in home-based seed sprouting, in which individuals can grow sprouts at home. In conventional, home-based seed sprouting, seeds are placed in a first container, such as a jar. Before the seeds sprout, they are kept wet by soaking and/or periodically rinsing the seeds within the container. After the seeds begin to the sprout, the sprouts are kept moist, but should not be kept overly moist or wet, which may stunt or stop sprout growth. During this growth phase, the sprouted seeds are placed in a second container, such as a tray, where the sprouts can grow in an open environment until harvested.

Because these conventional, home-based seed sprouting practices required proper watering and timely transport of the seeds between separate containers, individuals can make mistakes in caring for the sprouts, which result in low crop yields or crop failure. Accordingly, it would be beneficial to improve sprouting techniques and systems to minimize the labor and accuracy required to produce optimal seed sprout harvests.

### SUMMARY

Devices for growing sprouts, also known as sprouters, and methods for using sprouters are taught in this document. Exemplary sprouters may include at least one tray or a plurality of trays configured to stack vertically. The trays may be formed from a hydrophobic material. They trays may each include a side wall and a bottom surface, the bottom surface having a plurality of openings. The sprouter may include a lid configured to cover the open top of one of the plurality of trays and a collection tray configured to collect water from the plurality of trays.

In some embodiments, the plurality of openings may be in fluid communication with the collection tray. The bottom surface may include at least one raised feature and the plurality of openings may extend through the bottom surface and the at least one raised feature. The bottom surface and the side wall may define a volume having an open top. The side wall may be translucent.

The hydrophobic material may be polypropylene and the plurality of openings each having a diameter of about 1/16″. The sprouter may be configured to automatically adjust the maximum water levels in the at least one tray depending on whether seeds in the tray are germinated and growing or soaking.

Exemplary sprouters may be used by performing a number of steps, including: placing seeds in at least one tray; placing the at least one tray on a collection tray; pouring water in the at least one tray; providing holes in the at least one tray; providing a maximum water level in the at least one tray for soaking seeds; automatically adjusting the maximum water level when the seeds germinate; and collecting water in excess of the maximum water level in the collection tray.

In some embodiments, the at least one tray may be a plurality of trays, and further include the step of stacking the plurality of trays vertically, wherein water from a top tray in the vertical stack supplies the others of the plurality of trays through the holes in the top tray. The top tray may be covered with a lid. Water may be supplied to the plurality of trays by pouring water in the top tray.

In other embodiments, the at least one tray may be formed from a hydrophobic material and the holes in the at least one tray may be sized such that the surface tension of pure water and the hydrophobic properties of the tray material resists passage of the pure water through the holes. The automatically adjusting may be facilitated by germinating seeds soaking in water changing the surface tension of the soaking water and reducing the resistance to passage through the holes. The seeds are placed on and around the raised features. Water in the collection tray is used in the step of pouring water.

### BRIEF DESCRIPTION OF THE DRAWINGS

The following description can be better understood in light of the Figures, in which:

FIG. 1 shows a perspective view of some embodiments of an exemplary sprouter having multiple trays;

FIG. 2 shows a perspective view of some embodiments of an exemplary sprouter having multiple trays with transparent sidewalls;

FIG. 3 shows a perspective view of some embodiments of an exemplary tray for use with a sprouter;

FIG. 4 shows a top view of some embodiments of the tray shown in FIG. 3;

FIG. 5 shows a bottom view of some embodiments of the tray shown in FIG. 3;

FIG. 6 shows a cross section view of some embodiments of an exemplary sprouter having multiple trays containing growing sprouts;

FIG. 7a shows a cross section view of some embodiments of an exemplary tray containing seeds that are unsprouted;

FIG. 7b shows a cross section view of some embodiments of the tray shown in FIG. 4a containing seeds that are germinated;

FIG. 7c shows a cross section view of some embodiments of the tray shown in FIGS. 7a and 7b containing seeds that are sprouted and growing; and

FIG. 8 shows a flowchart of some embodiments of a method of growing seed sprouts in the sprouter.

The Figures illustrate specific aspects of exemplary sprouters and methods for making such devices. Together with the following description, the Figures demonstrate and explain the principles of the methods and structures produced through these methods. Some dimensions and thicknesses may be exaggerated for illustration purposes. The same reference numerals in different drawings represent the same element, and thus their descriptions will not be repeated.

### DETAILED DESCRIPTION

The following description supplies specific details in order to provide a thorough understanding. Nevertheless, the skilled artisan would understand that the sprouter and associated methods of making and using the sprouter can be implemented and used without employing these specific details. Indeed, the sprouter and associated methods can be placed into practice by modifying the illustrated devices and methods and can be used in conjunction with any other apparatus and techniques conventionally used in the industry.

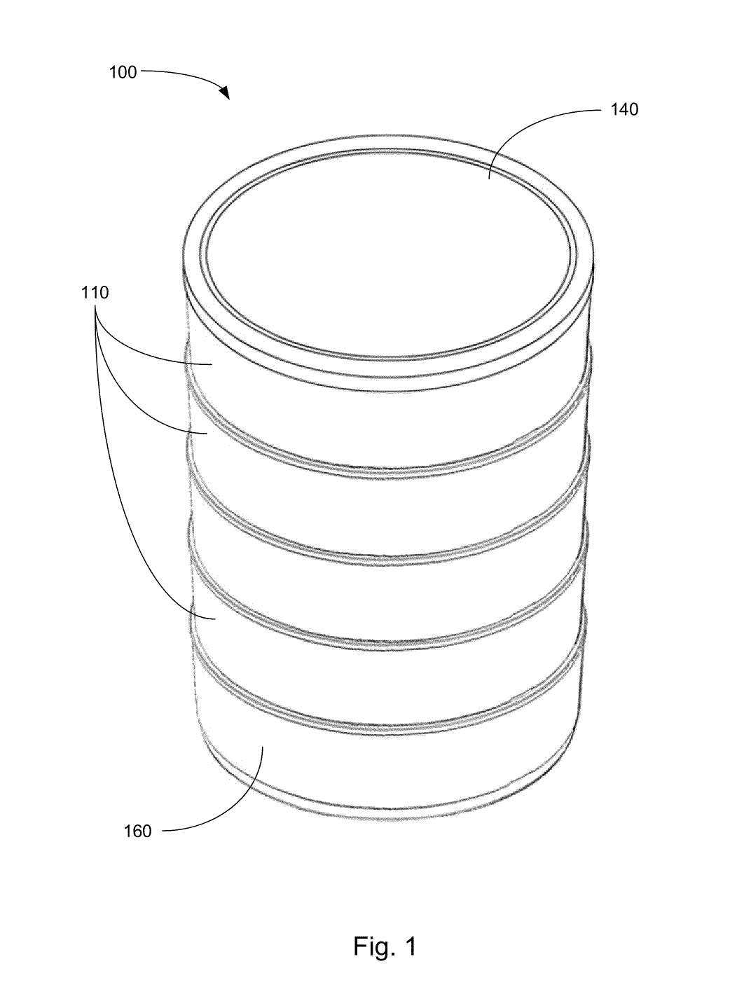

Some embodiments of a sprouter 100 and methods for using such are shown in FIGS. 1-8. The sprouter 100, as shown in FIG. 1, may generally include one or more growth trays 110, a collection tray 160, and a lid 140. Some embodiments may include a single growth tray 110, while other embodiments may include multiple growth trays 110, such as 3, 5, 10, 15, or more than 15 growth trays 110. Each of growth trays 110 can be stacked vertically on top each other and on top of the collection tray 160, and the lid 140 can be placed on top of the topmost growth tray 110. In use, seeds 132 can be placed within each growth tray 110 and left there during the entire growth process, from soaking to harvesting. Thus, there may be no need to move germinated or sprouted seeds between multiple containers, as is required in some conventional seed sprouting techniques. This can simplify the process of growing seed sprouts and also reduce the likelihood of damaging the sprouted or germinated seeds while transporting them from one container to another or forgetting to transport the seeds at the proper time. Moreover, by vertically stacking the growth trays 110, as shown, a user can efficiently utilize available space for growing sprouts.

In some embodiments, each of the growth trays 110 may be stackable, such that multiple growth trays 110 can be stacked vertically on top of one another to form the body of the sprouter 100. In some configurations, the bottom portion of each growth tray 110 can be slidably received into a top opening of a lower growth tray 110 when stacked to stabilize the stack of growth trays 110. In some configurations, the interface 118 between adjacent growth trays 110 can further or alternatively include an interlocking feature that selectively locks adjacent growth trays 110 together to prevent the unintentional removal of one growth tray 110 from another. In use, each of the one or more growth trays 110 can be selectively lifted off of a lower growth tray 110 or the collection tray 160 so that a user can access the contents of the lower tray.

In some embodiments, the collection tray 160 may form the base of the sprouter 100 and collect water that seeps downwards through the one or more growth trays 110. Accordingly, the collection tray 160 can be shaped and configured to form a dish or other semi-enclosed container that can retail a liquid therein. In some configurations, the collection tray 160 that has no holes except for a top opening into which is inserted the bottom side of a growth tray 110. In other configurations, the collection tray 160 may include one or more polls disposed on a side portion of the collection tray 160 that forms an outlet for water when the collection tray 160 is filled or nearly filled with water. The collection tray 160 can be sized to collect various quantities of water, such as between about 1 cup of water and about 10 cups of water, between about 2 cups of water and about 4 cups of water, or more than about 10 cups of water. In some configurations, the collection tray 160 can have substantially the same shape and size as the one or more growth trays 110.

In some embodiments, a lid 140 may be placed on the top of topmost growth tray 110 to cover the opening of the topmost growth tray 110. The lid can form a solid barrier between the topmost growth tray 110 can assist to retain moisture and odors within the sprouter 100. In some configurations, this barrier may be airtight, while in other embodiments this barrier can permit air to flow therethrough. The lid 140 can be removable so that a user can access the contents of the topmost growth tray 110. In other embodiments, a lid 140 may not be included with the sprouter 110.

Referring still to FIG. 1, in some configurations, the combination of the lid 140, one or more of the growth trays 110, and the collection tray 160 may form a substantially enclosed container. Moreover, in some embodiments, there may be no substantial openings or air holes between the interior of the growth trays 110 and the external environment when the one or more growth trays 110 are properly stacked and the lid 140 is properly positioned. In other embodiments, one or more air holes may be placed in the lid 140, the one or more growth trays 110, and/or the collection tray 160.

In some embodiments, one or more of the lid 140, the one or more growth trays 110, and/or the collection tray 160 may be made of a durable, water-proof material. Non-limiting examples of materials that can be used to manufacture these parts of the sprouter 100 may include glass, ceramics, composite materials, and other suitable materials. In some instances, these parts can be made of a thermoplastic polymer such as polypropylene, polyethylene, polyvinyl chloride, or other suitable material. In some embodiments, the growth trays 110 may be formed of or coated with a material that is hydrophobic in nature, such as PTFE, polypropylene, poly (ether imide), poly (vinylidene fluoride) and polysulfones or other suitable materials. In some configurations, the lid 140, the one or more growth trays 110, and/or the collection tray 160 are formed at least partially in an injection molding, vacuum forming, hydroforming, or other suitable process.

The sprouter 100 can have various shapes and sizes. As shown in FIG. 1, in some embodiments, the sprouter 100 may have a cylindrical shape, such that each of the growth trays 110, the collection tray 160, and the lid 140 may have a circular horizontal cross-section. In other embodiments, these parts may have a non-circular cross-section, such as a square cross-section or a cross-section having the shape of another polygon. The sprouter 100 can be made to have various heights that depend in part on the number and size of each individual growth tray 110 and the collection tray 160. In some configurations, the height of each individual growth tray 110 may be between about 1 inch and about 4 inches, between about 1.5 inches and about 3 inches, or between about 1.5 inches and about 2.5 inches. In some configurations, the length, width, and/or circumference of each individual growth tray 110 may be between about 2 inches and about 24 inches, between about 3 inches and about 12 inches, or between about 4 inches and about 8 inches.

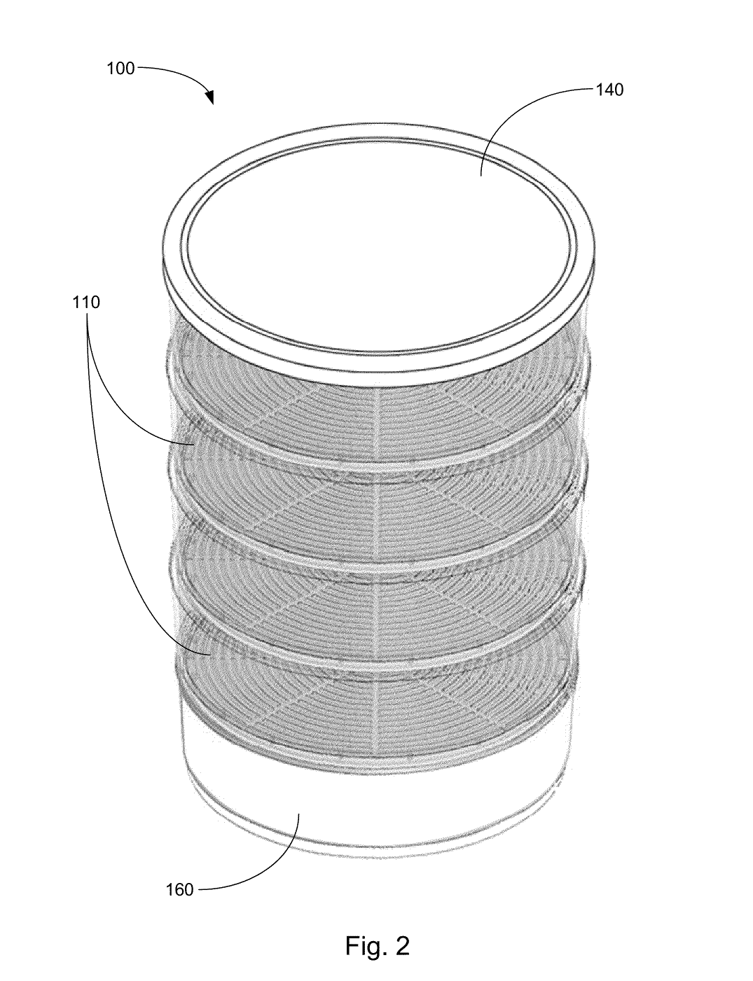

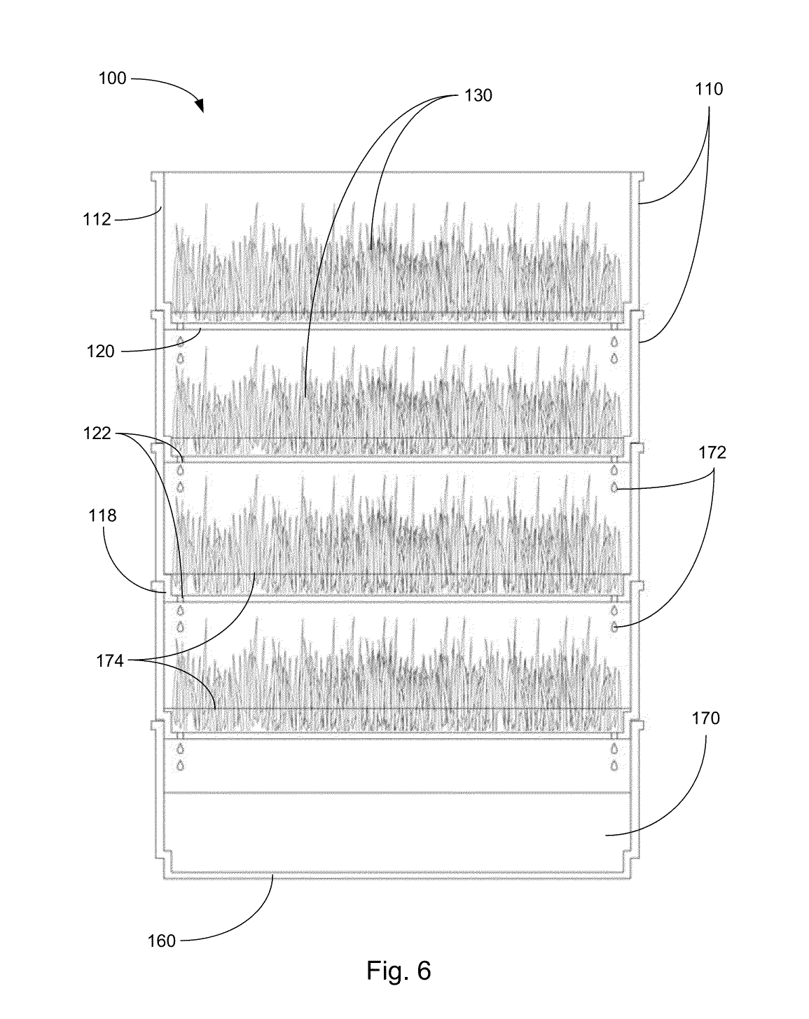

FIG. 2 shows some embodiments of the sprouter 100 with one or more growth trays 110 made of a transparent or semi-transparent material. Such material can permit light to enter into each tray as may be beneficial for at least some of the phases of sprout growth. As shown, these materials may allow the bottom surface of each growth tray 110 to be seen through the sidewall of each growth tray 110. As shown, in some configurations, the bottom surfaces of each growth tray 110 may include a textured surface or a pattern of raised ribs whereon seeds can be placed, sprouted, and grown to maturity. FIG. 6 shows some embodiments of a growth tray 110 that may include a floor 120 and sidewalls 112. In some embodiments, one or more raised ribs 124 may extend upwards from the floor 120 of the growth tray 110. The raised ribs 124 can be disposed in a predetermined pattern, such as the illustrated circular-type pattern. The raised ribs 124 can be disposed in other such patterns such as straight rows or in rows that extend from center of the floor 120 to near the sidewall(s) 112. In other embodiments, the floor 120 may include a textured surface rather than raised ribs 124. In some configurations, the raised ribs 124 can extend upwards between about 1/32 of an inch to about ⅛ of an inch. The raised ribs 124 or textured surface can reduce the amount of water required within the bottom surface of the growth tray 110.

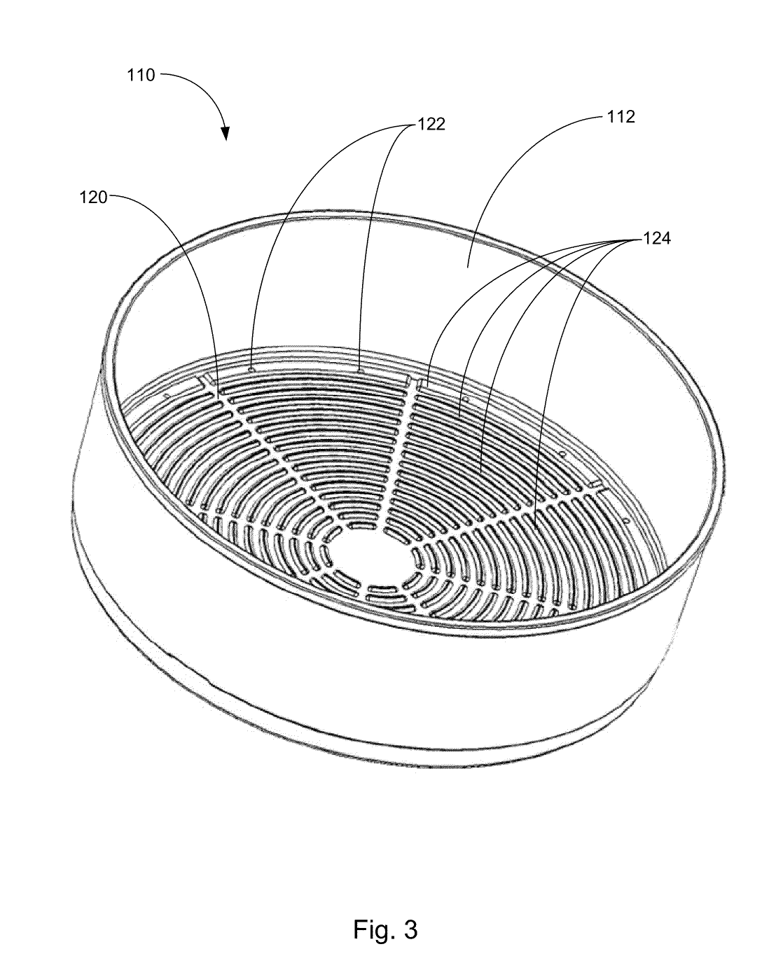

As shown in FIG. 3, in some configurations, the one or more holes 122 in the floor 120 of the growth tray 110 may be formed through a raised rib 124 or other raised structure. The height of the raised rib(s) 124 or other raise structures can be selected so that the height of the water level 174 is configured to be retained at a predetermined height after water has stopped draining from the one or more holes 122, as described above. Accordingly, even if the water within the growth tray 110 were to completely drain out of the holes 122 down to the level of the raised rib 124, there would still be water between the floor 120 and the top of the raised trip 124 within the growth tray 110, which could keep the seeds moist. Accordingly, in some embodiments, the height of the raised ribs 124 is selected based upon the desired water level 174 within the growth tray 110 after water has stopped draining from the one or more holes 122.

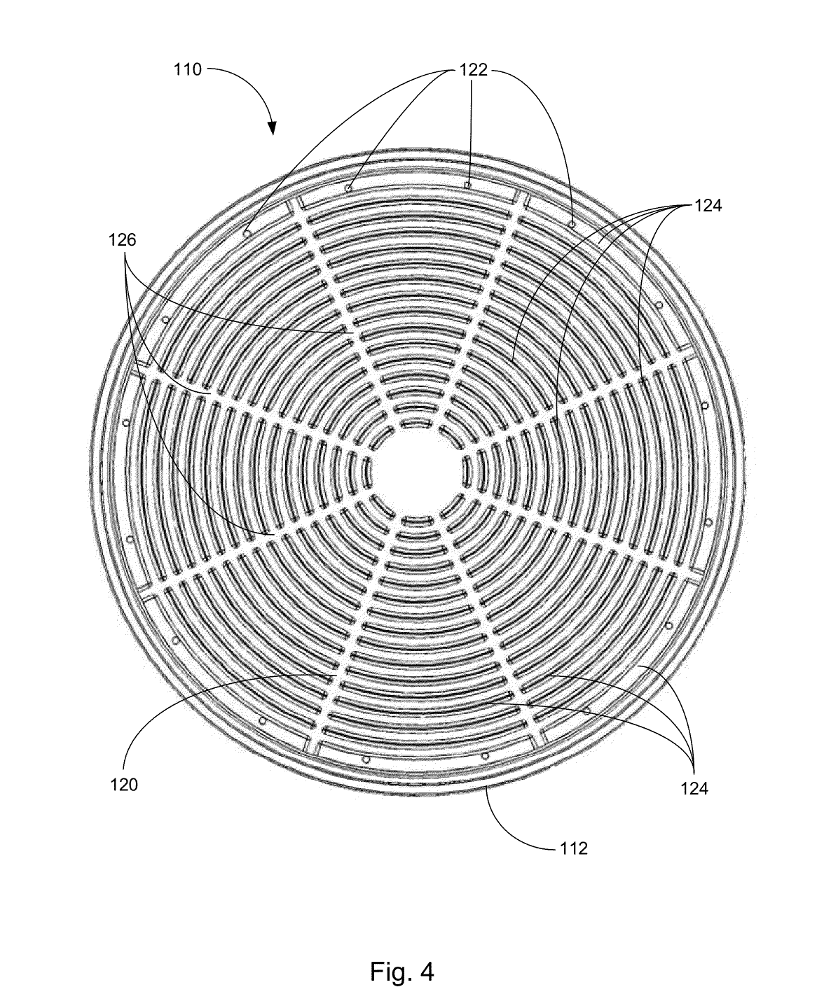

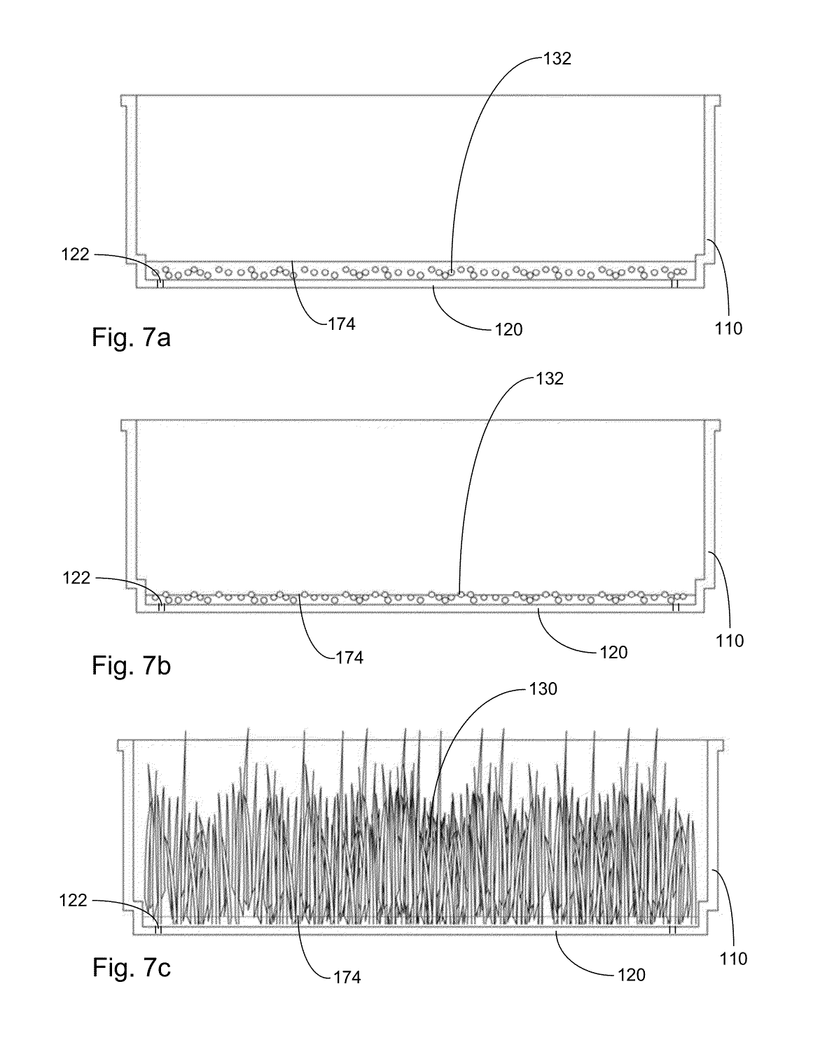

FIG. 4 shows a top view of the growth tray 110 of FIG. 3. This Figure depicts the circular-type pattern of the raised ribs 124 on the floor 120 of the growth tray 110. As shown, in some embodiments, one or more channels 126 can be formed through the pattern of the raised ribs 124 to facilitate fluid flow along the floor 120 of the growth tray 110. These channels 126 can ensure the water is substantially evenly distributed among the seeds or sprouts within the growth tray 110. As further shown, in some configurations, the one or more holes 122 can be formed through a raised rib 124 that is wider than the diameter of the one or more holes 122. In the embodiments shown in FIG. 7, the growth tray 110 includes sixteen holes. In other embodiments, the growth tray 110 can include more than sixteen holes for fewer than sixteen holes depending on the size of the growth tray 110 and size of the holes 122.

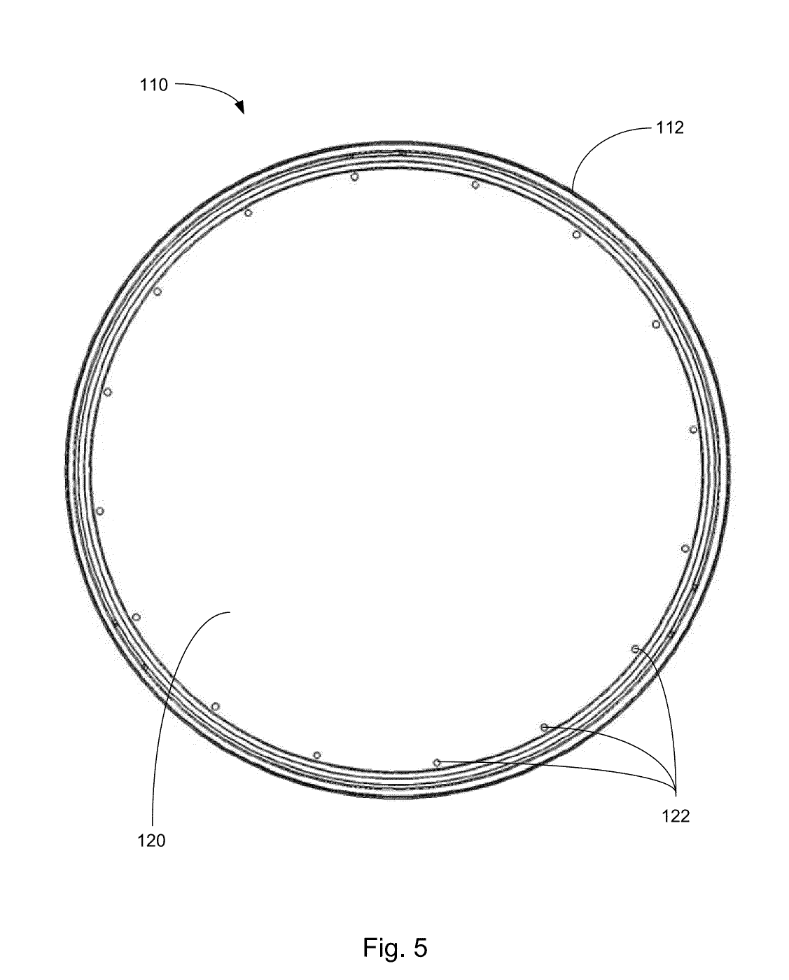

FIG. 5 shows a bottom view of the growth tray 110 FIGS. 3 and 4. As shown, in some embodiments, the holes 122 extend completely through the floor 120 of the growth tray 110. The floor of the growth tray 110 may also form a substantially flat and enclosed surface that can be inserted into the top of a lower growth tray 110 when stacked, as shown in FIG. 1.

FIG. 6 shows some embodiments of a sprouter 100 having four growth trays 110 stacked vertical upon a collection tray 160. Each growth tray 110 can include a floor 120 upon which seeds can be placed and one or more sidewalls 112 that can extend in a substantially vertical direction from the floor 120. The bottom portion of each growth tray 110 can include an inward-oriented ledge 118 that can be compatibly inserted into the top portion of an adjacent, lower growth tray 110. The inward-oriented ledge 118 can have outer dimensions that approximate the inner dimensions of the top portion of an adjacent, lower growth tray 110 such that the inwardly-oriented ledge 118 can be inserted within the adjacent growth tray 110 without excess space therebetween. In embodiments where growth tray 110 includes a circular, horizontal cross section, the inwardly-oriented ledge 118 can also include a circular, horizontal cross section having a smaller, outer diameter than the outer diameter of the main portion of the growth tray 110. In some configurations, the outer diameter of the inwardly-oriented ledge 118 may approximate the inner diameter of the opening of the growth tray 110.

In order to provide water to the seeds and sprouts 130 growing within each growth tray 110, one or more holes 122 can be formed through the floor 120 of each growth tray 110. The holes 122 may be formed within an outer ring of the raised ribs 124 to provide a residual amount of water that will remain in the growth tray 110. In some instances, as water 172 is poured into the top growth tray 110, it trickles down through the one or more holes 122 to the growth tray 110 below it. This trickling process continues until any excess water 172 is collected in the collection tray 160. Accordingly, a user may water the seeds 132 or sprouts 138 by adding an adequate amount water into the top growth tray 110, which then trickles down into each of the lower growth trays 110 through the holes 122.

Referring still to FIG. 6, in some embodiments, the material used to form the one or more growth trays 110 and the size of the one or more holes 122 may be selected so that the surface tension between the one or more holes 122 and the water 172 is large enough that some water 172 is retained within each tray after each watering. When the height of the water level 174 is above a certain height, the water pressure will be greater than the surface tension at the holes 122, causing some of the water 172 to pass through the holes 122. Once the water level 174 is below a certain height, the surface tension pressure at the holes 122 is less than the pressure and no more water flows. As such, proper selection of an appropriately hydrophobic material and correct sizing of the holes 122 can allow the correct amount of water to be automatically retained within each growth tray 110, which can minimize the watering accuracy required for users to accurately water the seeds or sprouts 130. In these instances, some water will be retained within each of the growth trays 110. Accordingly, by adjusting the size of the one or more holes 122 in the growth trays 110 or by using materials with different hydrophobic properties, the height of the water level 174 retained within each growth tray 110 can be adjusted.

For example, in some configurations, the height of the water level 174 retained in the growth trays 110 after water 172 has stopped draining therefrom, when there are no germinated or sprouted seeds within the growth trays 110, is about ¼″ to about 3/16″. In other configurations, this height may be about 1/16″ to about ⅛″. Moreover, in some embodiments, the size of the holes 122 that may provide the above-listed water levels 174 can be from about 1/64″ to about ⅛″. In some embodiments, the size of the one or more holes is about 1/16″.

Some different stages of growing sprouts 130 from seeds 132 using the sprouter 100 are shown in FIGS. 7a to 7c. To grow sprouts 130 within the growth tray 110, the desired seeds 132 may be placed on the bottom surface 120 of the growth tray 110. Some common varieties of seeds including alfalfa, mung bean, broccoli, watercress, wheat berry, soybean, and clover may be grown in the sprouter 110. To initiate growth, the seeds 132 are soaked in water. Generally, the seeds 132 may need to be soaked for approximately one to three days or possibly longer until germination. Accordingly, as mentioned above, the size of one or more holes 122 in the growth tray 110 and the material used to form the growth tray 110 are selected such that the one or more holes 122 stops draining water when the water level 174 reaches a predetermined height. In this way, each growth tray 110 can retain enough water to properly soak the seeds 132 until germination. In some configurations, the one or more holes 122 and the growth tray 110 are configured such that the water level water level is about ¼″ to about ⅜″ of an inch when un-germinated seeds are contained within the growth tray 110.

FIG. 7b shows the growth tray 110 and seeds 132 of FIG. 4a after the seeds 132 begin to germinate and sprout. It has been recognized, that when seeds 130 begin to germinate they release one or more enzymes into the water 172 within the growth tray 110 which can affect the surface tension of the water 172, which consequently affects the force required to push the water 172 through the holes 122. These enzymes have been observed to decrease the surface tension of the water 174, which subsequently can reduce the height of the water level 174 within the tray. Advantageously, at the same time the seeds 132 begin to germinate and release these enzymes, the seeds 132 are no longer required to be soaked in water 172. At this point, the seeds 132 are beginning to sprout and entered a growth stage in which they may require a lower water level 174 in order to be kept moist for optimal growth. Accordingly, in some configurations, the one or more holes 122 and the growth tray 110 may be configured such that the water level may be maintained at about 1/32″ to about 3/16″ when germinated seeds release one or more enzymes into the water 172.

FIG. 7c shows the growth tray 110 of FIGS. 7a and 7b after the seeds 132 have grown into mature sprouts 130. At this point, the sprouts 130 can be harvested and eaten or cooked. Between the period of seed sprouting and sprout harvesting, the sprouts should be kept moist, but should not be overwatered, which may stunt or prohibit growth. During growth, the seeds 132 and/or the growing sprouts 130 may continue to release one or more enzymes that affect the surface tension between the one or more holes 122 and the water 172 within the growth tray 110. Accordingly, during sprout growth, the height of the water level 172 may be lower than the height of the water level 172 present in the growth tray 110 during seed soaking. Accordingly, as shown, water may be placed periodically into the one or more growth trays 110, particularly into the top tray. For example, sprouts may be watered with about ½ cup two times per day while they are growing. As previously described, as water may only need to be placed into the topmost growth tray 110, from which the water can drain through the one or more holes 122 into any lower growth trays 110, and finally into the reservoir 170 of the bottom tray 160.

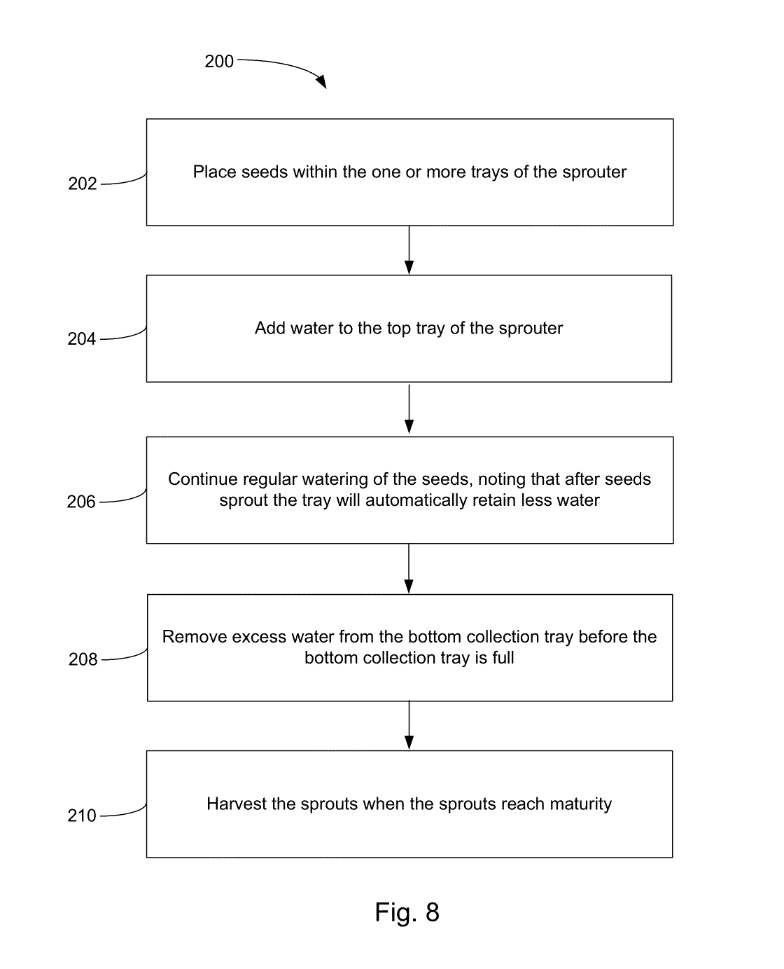

FIG. 8 shows a flowchart of a method 200 for growing sprouts within sprouter. In step 202, seeds may be placed within the one or more growth trays of the sprouter. For effective growth, the seeds 132 may be evenly spread across the bottom surface of the one or more growth trays. When more than one growth tray is used, the growth trays can be stacked on top of each other and on top of a collection tray. In step 204, water may be added to the top growth tray of the sprouter. Water may be added until each growth tray includes an adequate amount of water and stops draining excess water. In some instances, such as when sprouter includes between about one to about four growth trays, a half of a cup of water may be all that is required to be placed into the top growth tray two times per day. If the sprouter includes more than four growth trays, more than about a half of a cup water may be needed.

In step 206, the user may continue water this seeds regularly, noting that after this seeds sprout, the growth trays will automatically retain less water. In step 208, the user removes excess water from the reservoir 170 from the collection tray 160 before the collection tray 160 becomes full. Lastly, in step 210, the user may harvest the sprouts 130 when the sprouts 130 reach maturity. The period from seed sprouting to maturity will be based on the type of seed and the environmental conditions, and they generally take between about a couple of days to about several weeks. In some instances, the method 200 further includes removing and replacing the lid each time water is added to the sprouter. It has been observed, that the act of opening the lid twice a day may provide enough oxygen to the sprouts for adequate sprout grow.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, examples are meant to be illustrative only and should not be construed to be limiting in any manner.

What is claimed is:

1. A device for growing sprouts, the device comprising:
at least one tray, the at least one tray being configured to stack vertically, the at least one tray being formed from a hydrophobic material, wherein the at least one tray includes,
a side wall, and
a bottom surface, the bottom surface having a plurality of openings;
a lid; and
a collection tray configured to collect water from the plurality of trays.

2. The device of claim 1, wherein the plurality of openings are in fluid communication with the collection tray.

3. The device of claim 1, wherein the bottom surface includes at least one raised feature.

4. The device of claim 3, wherein the plurality of openings extend through the bottom surface and the at least one raised feature.

5. The device of claim 1, wherein the bottom surface and the side wall define a volume having the open top.

6. The device of claim 5, wherein the lid is configured to cover the open top of one of the at least one trays.

7. The device of claim 1, wherein the hydrophobic material is polypropylene and the plurality of openings each have a diameter of about 1/16″.

8. The device of claim 1, wherein the side wall is translucent.

9. The device of claim 1, wherein the device is configured to automatically adjust the maximum water levels in the at least one tray depending on whether seeds in the tray are germinated and growing or soaking.

10. A method of growing sprouts, the method comprising:
placing seeds in at least one tray;
placing the at least one tray on a collection tray;
pouring water in the at least one tray;
providing holes in the at least one tray;
providing a maximum water level in the at least one tray for soaking seeds;
automatically adjusting the maximum water level when the seeds germinate; and
collecting water in excess of the maximum water level in the collection tray.

11. The method of claim 10, wherein the at least one tray is a plurality of trays, the method further comprising:
stacking the plurality of trays vertically, wherein water from a top tray in the vertical stack supplies the others of the plurality of trays through the holes in the top tray.

12. The method of claim 11, further comprising a covering the top tray with a lid.

13. The method of claim 11, further comprising supplying water to the plurality of trays by pouring water in the top tray.

14. The method of claim 10, wherein the at least one tray is formed from a hydrophobic material.

15. The method of claim 14, wherein the holes in the at least one tray are sized such that the surface tension of pure water and the hydrophobic properties of the tray material resists passage of the pure water through the holes.

16. The method of claim 15, wherein the automatically adjusting is facilitated by germinating seeds soaking in water changing the surface tension of the soaking water and reducing the resistance to passage through the holes.

17. The method of claim 10, wherein the at least one tray is formed of a translucent material.

18. The method of claim 10, wherein the at least one tray includes raised features, and wherein the seeds are placed on and around the raised features.

19. The method of claim 18, wherein the holes extend through the raised features.

20. The method of claim 10, wherein water in the collection tray is used in the step of pouring water.
